(19) United States
(12) Patent Application Publication
(10) Pub. No.: US 2020/0237110 A1
(43) Pub. Date: Jul. 30, 2020

(54) STRUCTURE OF INFLATABLE MATTRESS AND SYSTEM THEREOF

(71) Applicant: EVERMAX ECO INDUSTRY LTD., Jiashan (CN)

(72) Inventor: TA-SEN WEN, JIASHAN (CN)

(21) Appl. No.: 16/260,327

(22) Filed: Jan. 29, 2019

(51) Int. Cl. A47C 27/08

(52) U.S. Cl. CPC A47C 27/082; A61G 7/05769; A47C 27/087

(57) ABSTRACT

An improved structure of an inflatable mattress includes: an upper surface layer and a lower surface layer, and a gas blocking layer and a gas penetrating layer arranged in sequence, from bottom to top, between the upper surface layer and the lower surface layer. The gas penetrating layer is formed with a plurality of openings. Circumferential edges of the upper surface layer, the gas blocking layer, the gas penetrating layer, and the lower surface layer are processed to form hermetic sealing so as to form the inflatable mattress. An inflatable mattress system is also provided, including an inflatable mattress connected to a gas supply module. Heated gas is generated by the gas supply module and supplied into a receiving space of the inflatable mattress. A user, when lying on the mattress, perceives the heated gas releasing from the interior of the inflatable mattress to achieve an effect of warm keeping.

### FIELD OF THE INVENTION

The present invention relates to an improved structure of an inflatable mattress and a system thereof, and more particular to an improved structure of an inflatable mattress that includes a multilayer configuration for comfortable and safe use by a user and is operable to charge gas into the inflatable mattress by a gas supply module.

### BACKGROUND OF THE INVENTION

In cold winter days, weather is often humid and very cold. This often causes poor blood circulation for the elderly, infants, and the weak poor whose blood may not properly circulate to the extremes, particularly for those having no heating devices or only having poor heating performance. It becomes hard for such people to have their extremes warmed when they are sleeping, even though they are covered with thick blankets or quilts. An electric blanket positioned between a mattress and the body of a user or a heating mattress might be a good measure for keeping warm, allowing such people to sleep comfortably.

However, the electric blanket or heating mattress is a contact type electric heating device that comprises electric heating elements (such as electric heating filaments) that are embedded, through weaving or knitting, in the blanket or the mattress to generate heat, upon being energized, for keeping the user warm. Although being convenient for use, such devices consumes a large amount of energy for long term use, and might cause perception of scorching and result in unexpectedly burn of the user. Fire might even be caused in case of poor device quality or improper use, leading to loss of lives and properties.

Further, the electric blanket or heating mattress may get dirty or contaminated after long term use; however, direct water washing is generally prohibited, otherwise insulating characteristics might be damaged or deteriorated, leading to electric leaking and thus causing catastrophes. Further, the known heating mattress is generally not foldable for easy storage and would occupy a large amount of space of living.

In view of the above, the present invention aims to provide an improved structure of an inflatable mattress and a system thereof, which help overcome the above-discussed drawbacks and provide better industrial utilization.

### SUMMARY OF THE INVENTION

An objective of the present invention is to provide an improved structure of an inflatable mattress. The inflatable mattress is designed with a multilayer configuration such that heated air may be filled in the inflatable mattress to allow a user, who lies down on the mattress, to perceive a high temperature released from inside the inflatable mattress to achieve an effect of warming, and in addition, water washing or machine washing are possible before inflation or after deflation for cleaning and also for storage through folding.

To achieve the above objective, the present invention provides an improved structure of an inflatable mattress, comprising: an upper surface layer and a lower surface layer, and a gas blocking layer and a gas penetrating layer arranged in sequence, from bottom to top, between the upper surface layer and the lower surface layer, wherein the gas penetrating layer is formed with a plurality of openings; circumferential edges of the upper surface layer, the gas blocking layer, the gas penetrating layer, and the lower surface layer are processed to form hermetic sealing to form an inflatable mattress, wherein the inflatable mattress is provided with a gas inlet hole to allow gas to be conveyed through the gas inlet hole into a receiving space of the inflatable mattress.

In the improved structure of the inflatable mattress described above, an internal portion and a circumferential edge of the inflatable mattress are both subjected to processing through hot pressing or radio frequency welding so as to form at least one jointed site in the internal portion of the inflatable mattress, with a part that is not subjected to processing of hot pressing or radio frequency welding being formed as a flow channel.

In the improved structure of the inflatable mattress described above, the flow channel is arranged to curve forth and back between two opposite ends of the inflatable mattress as extending from one of the ends of the inflatable mattress toward an opposite one of the ends.

In the improved structure of the inflatable mattress described above, the plurality of openings of the gas penetrating layer are formed through being punched with a punching machine.

In the improved structure of the inflatable mattress described above, the gas blocking layer and the gas penetrating layer are each formed of a thermoplastic polyurethane (TPU) film.

In the improved structure of the inflatable mattress described above, the TPU film further comprises hydrophilic groups contained therein.

In the improved structure of the inflatable mattress described above, the upper surface layer has a thickness that is greater than a thickness of the lower surface layer.

In the improved structure of the inflatable mattress described above, the upper surface layer and the lower surface layer each comprise a piece of fabric.

In the improved structure of the inflatable mattress described above, the inflatable mattress is combinable with an internal side of bedding.

Another objective of the present invention is to provide an inflatable mattress system, which comprises a gas supply module used in combination with an inflatable mattress in order to charge heated gas into the inflatable mattress for providing an effect of keeping warm of a user, so as to take the place of a known structure of heat generation that involves electric heating elements but without the potential risks of electricity leaking or shorting that might occur in a known electric blanket or a heating mattress to thereby improve safety of use.

Thus, the present invention also provides an inflatable mattress system, which comprises an inflatable mattress, which comprises an upper surface layer and a lower surface layer, and a gas blocking layer and a gas penetrating layer arranged in sequence, from bottom to top, between the upper surface layer and the lower surface layer, wherein the gas penetrating layer is formed with a plurality of openings; circumferential edges of the upper surface layer, the gas blocking layer, the gas penetrating layer, and the lower surface layer are processed to form hermetic sealing to form an inflatable mattress; and the inflatable mattress is provided with a gas inlet hole; and a gas supply module, which comprises a heating machine and a gas supply tube, wherein the gas supply tube is connectable to the gas inlet hole to supply heated gas generated by the heating machine into a receiving space of the inflatable mattress.

In the inflatable mattress system described above, an internal portion and a circumferential edge of the inflatable mattress are both subjected to processing through hot pressing or radio frequency welding so as to form at least one jointed site in the internal portion of the inflatable mattress, with a part that is not subjected to processing of hot pressing or radio frequency welding being formed as a flow channel.

In the inflatable mattress system described above, the flow channel is arranged to curve forth and back between two opposite ends of the inflatable mattress as extending from one of the ends of the inflatable mattress toward an opposite one of the ends.

In the inflatable mattress system described above, the plurality of openings of the gas penetrating layer are formed through being punched with a punching machine.

In the inflatable mattress system described above, the gas blocking layer and the gas penetrating layer are each formed of a thermoplastic polyurethane (TPU) film.

In the inflatable mattress system described above, the TPU film further comprises hydrophilic groups contained therein.

In the inflatable mattress system described above, the upper surface layer has a thickness that is greater than a thickness of the lower surface layer.

In the inflatable mattress system described above, the upper surface layer and the lower surface layer each comprise a piece of fabric.

In the inflatable mattress system described above, the inflatable mattress is combinable with an internal side of bedding.

In the inflatable mattress system described above, the heating machine further comprises a temperature control unit.

In the inflatable mattress system described above, the heating machine further comprises a timer unit.

In summary, in addition to novelty concerning spatial configuration, the present invention also provides various advantages over the prior art devices, and is thus in full compliance with requirements for patent in respect of novelty and non-obviousness.

### BRIEF DESCRIPTION OF THE DRAWINGS

FIG. 1 is an exploded view illustrating an improved structure of an inflatable mattress according to the present invention;

FIG. 2 is a perspective view illustrating the improved structure of the inflatable mattress according to the present invention;

FIG. 3 is a cross-sectional view, in a sketch form, illustrating the improved structure of the inflatable mattress according to the present invention;

FIG. 4 is a perspective view, illustrating an inflatable mattress system according to a first example of this invention; and

FIG. 5 is a perspective view, illustrating an inflatable mattress system according to a second example of this invention.

### DETAILED DESCRIPTION OF THE PREFERRED EMBODIMENTS

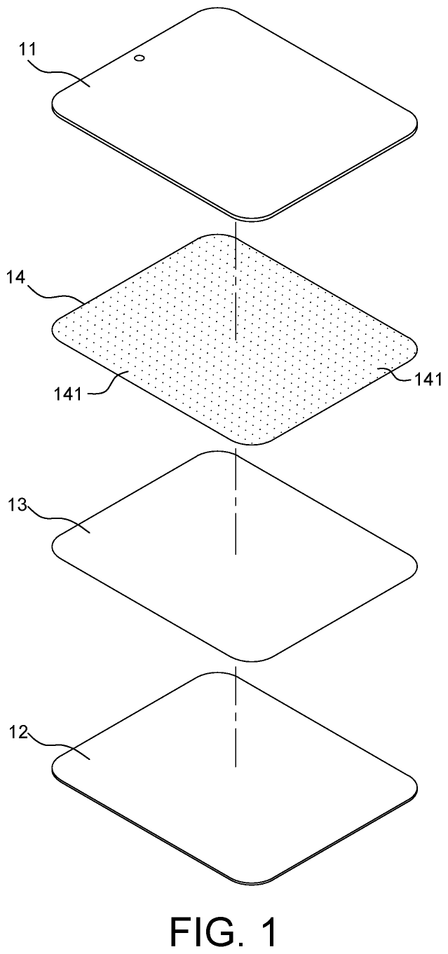

Embodiments of the present invention will be described herein with reference to FIGS. 1-5. The description is not provided to limit the ways of embodying the present invention, and is provided for illustrating one or some ways of embodying this invention. Similar to identical reference numerals are used to designate components or parts that are identical, substantially identical, or functionally identical throughout all the drawings and the embodiments. The drawings, for simplification, may be presented in a sketched form, and the drawings may not be drawn to correct scale and size for all or some of the embodiments.

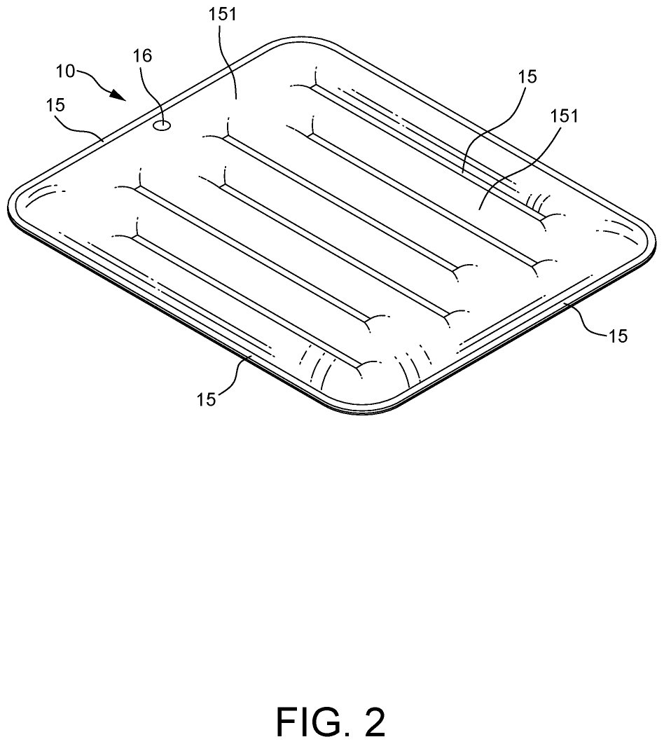

Firstly, referring to FIGS. 1 and 2, the present invention provides an improved structure of an inflatable mattress 10, which comprises: an upper surface layer 11 and a lower surface layer 12, and a gas blocking layer 13 and a gas penetrating layer 14 that are arranged, in sequence from bottom to top, between the upper surface layer 11 and the lower surface layer 12. The gas blocking layer 13 and the gas penetrating layer 14 are each a thermoplastic polyurethane (TPU) film. The TPU film further comprises hydrophilic groups contained in the film so that the inflatable mattress 10 has excellent functions of water resistance and humidity penetration to keep a user dry. Further, the gas penetrating layer 14 is formed with a plurality of openings 141. Those openings 141 can be formed as being punched open with a press or punching machine or being formed with manual operations. Further, circumferential edges of the upper surface layer 11, the gas blocking layer 13, the gas penetrating layer 14, and the lower surface layer 12 are processed for hermetical sealing to form the inflatable mattress 10. The inflatable mattress 10 is provided with a gas inlet hole 16, so that the gas inlet hole 16 may convey gas into a receiving space of the inflatable mattress 10. Before inflation, since there is no electric heating element arranged in the receiving space of the inflatable mattress 10, in addition to enhancing operation safety, the inflatable mattress 10 can be washed and cleaned.

In addition, in case that hot pressing or radio frequency welding is applied to the circumference of the upper surface layer 11, the gas blocking layer 13, the gas penetrating layer 14, and the lower surface layer 12, when gas is charged into the inflatable mattress 10, the gas may flow around randomly in the receiving space of the inflatable mattress 10, and further, after inflation, the inflatable mattress 10 is expanded and swollen in the form of nearly a sphere, making it hard for a user to lie thereon. For such reasons, hot pressing or radio frequency welding is applied to both an interior portion and the circumferential edge of the inflatable mattress 10 at the same time so as to form at least one jointed site 15 in the interior portion of the inflatable mattress 10, allowing a portion that is not subjected to hot pressing or radio frequency welding to form at least one flow channel 151, which allows the gas that is supplied through the gas inlet hole 16 into the receiving space of the inflatable mattress 10 to flow and move through the flow channel 151. In addition, the jointed site 15 provide constraint so that the inflatable mattress 10, when inflated, gets expanded and swollen at a portion thereof that corresponds to the flow channel 151, making it not possible for the inflatable mattress 10 to expand, in the entirety thereof, into a nearly spherical shape that makes it hard for a user to comfortably lie flat on the inflatable mattress 10.

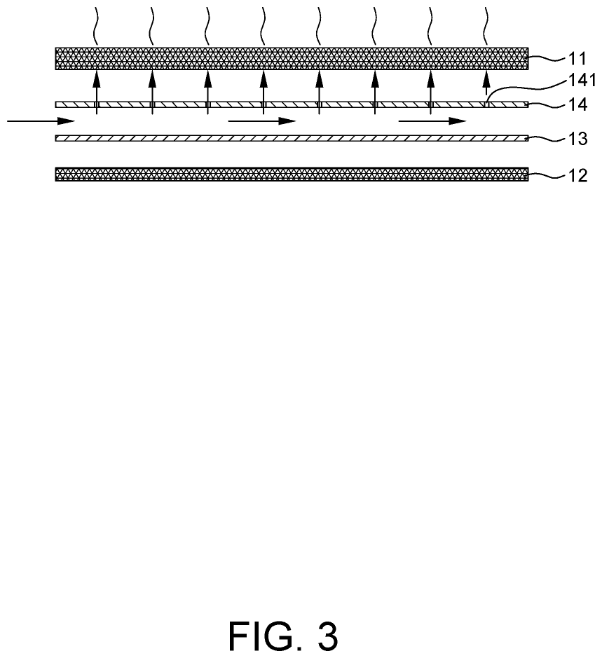

Next, referring to FIG. 3, when gas moves through the gas inlet hole 16 to get into the receiving space of the inflatable mattress 10, whether the flow channel 151 is formed or not, the gas that moves into a space between the gas blocking layer 13 and the gas penetrating layer 14 is blocked by the gas blocking layer 13 so as not to spread or propagate in a direction toward the lower surface layer 12 and is only allowed to spread or propagate through the plurality of openings 141 of the gas penetrating layer 14 toward the upper surface layer 11, such that the gas, as being heated gas having a high temperature, allows a user who is lying on or leaning against the inflatable mattress 10 to perceive the heated gas dissipate through or release from the upper surface layer 11. In addition, the gas blocking layer 13 also functions to block dust mites from passing therethrough to get to the upper surface layer 11 to cause discomfort of the user.

Further, the upper surface layer 11 and the lower surface layer 12 are each made of a material that comprises fabric or textile. The upper surface layer 11 has a thickness that is greater than a thickness of the lower surface layer 12.

Finally, the inflatable mattress 10 can be used alone, or can be combined with an internal side of bedding (not shown) and can be fixed in position by directly coupled to the internal side of the bedding, so as to prevent undesired skidding of the inflatable mattress 10, which may lead to deterioration of heat absorption by the human body, when a user turns around during sleeping.

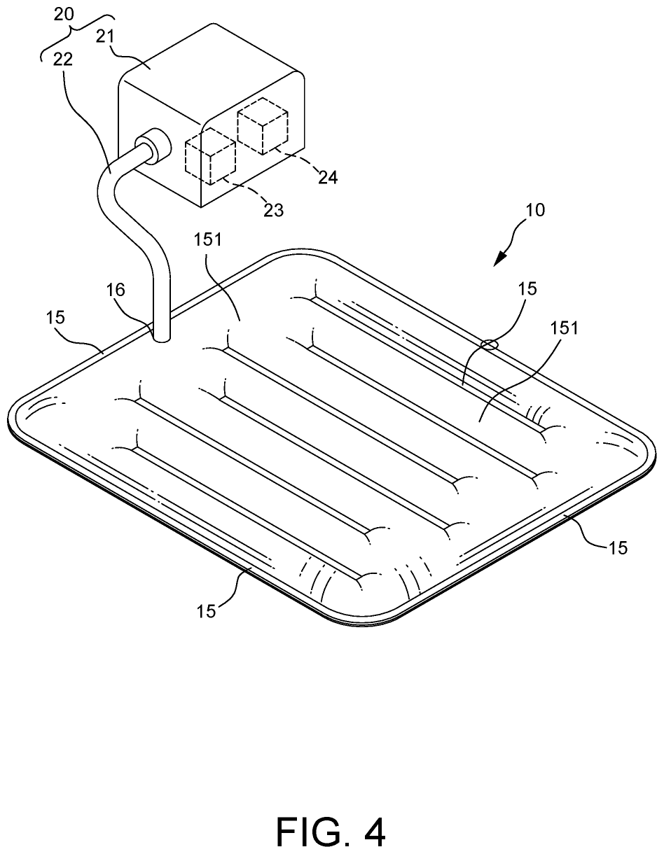

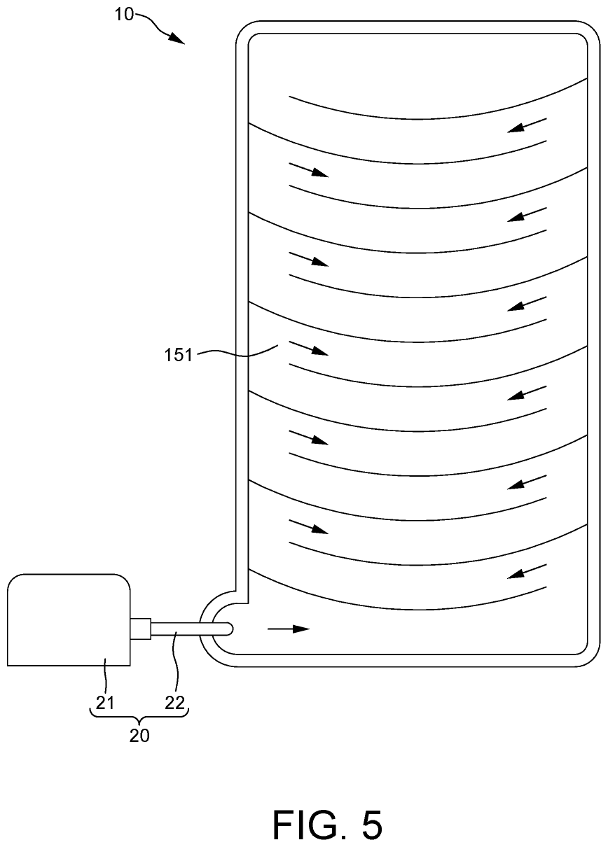

Further, referring to FIGS. 4 and 5, schematic views are provided to illustrate a first example and a second example of an inflatable mattress system according to the present invention. The present invention also provides an inflatable mattress, which comprises: an inflatable mattress 10, and the inflatable mattress 10 comprises an upper surface layer 11 and a lower surface layer 12, and a gas blocking layer 13 and a gas penetrating layer 14 that are arranged, in sequence from bottom to top, between the upper surface layer 11 and the lower surface layer 12, wherein the gas penetrating layer 14 is formed with a plurality of openings 141, and circumferential edges of the upper surface layer 11, the gas blocking layer 13, the gas penetrating layer 14, and the lower surface layer 12 are processed for hermetical sealing to form the inflatable mattress 10, and the inflatable mattress 10 is provided with a gas inlet hole 16; and a gas supply module 20, which comprises a heating machine 21 and a gas supply tube 22, wherein the gas supply tube 22 is connectable to the gas inlet hole 16 to supply heated gas generated by the heating machine 21 into a receiving space of the inflatable mattress 10.

Details of the inflatable mattress 10 can be referred to what described above and repeated description will be omitted. However, further reference may be made to FIG. 5, wherein the flow channel 151 is curved around between two ends of the mattress as alternately extending from one of the two ends of the inflatable mattress 10 toward an opposite one of the ends of the inflatable mattress 10. Thus, when the gas supply tube 22 of the gas supply module 20 is connected to the gas inlet hole 16 that is provided at one of the ends of the inflatable mattress 10, the heated gas supplied therethrough is conducted to move back and forth along the curved, serpentine configuration of the flow channel 151 from one of the ends of the inflatable mattress 10 toward the other one of the ends.

For example, when the gas inlet hole 16 is arranged at a tail end of the inflatable mattress 10, where the feet of a user may be positioned, the heated gas moves along the curved serpentine passages of the flow channel 151 to make the user perceive warming in sequence from the feet, through the waist, to the head, probably in a gradual manner, so that the entirety of the mattress is not of a similar or identical level of temperature, which may lead to discomfort of the user.

Finally, to regulate or adjust the temperature of the heated gas generated by the heating machine 21, the heating machine 21 further comprises a temperature control unit 23, so that a user to may operate the temperature control unit 23 to regulate or adjust the temperature of the heated gas supplied into the inflatable mattress 10. Further, the heating machine 21 further comprises a timer unit 24, so that a user may operate the timer unit 24 to set and adjust a time period during which the heating machine 21 is set in operation.

The present invention provides an improved structure of an inflatable mattress and a system thereof, wherein the improved structure of the inflatable mattress has a multilayer configuration, and is operable in combination with a gas supply module to allow the gas supply module to fill up a receiving space of the inflatable mattress with heated gas, so that a user, when lying thereon, may perceive the heated gas release from the interior of the inflatable mattress to achieve an effect of warm keeping, by which a known structure that involves electric heating elements for generating heat through energization can be replaced to eliminate the potential risk of electricity leaking or shorting found in a conventional electric blanket or heating mattress and to improve operation safety. In addition, before inflation or after deflation, it is possible to carry out water cleaning and machine washing for cleaning and storage through folding.

What is claimed is:

1. An improved structure of an inflatable mattress, comprising: an upper surface layer and a lower surface layer, and a gas blocking layer and a gas penetrating layer arranged in sequence, from bottom to top, between the upper surface layer and the lower surface layer, wherein the gas penetrating layer is formed with a plurality of openings; circumferential edges of the upper surface layer, the gas blocking layer, the gas penetrating layer, and the lower surface layer are processed to form hermetic sealing to form an inflatable mattress, wherein the inflatable mattress is provided with a gas inlet hole to allow gas to be conveyed through the gas inlet hole into a receiving space of the inflatable mattress.

2. The improved structure of the inflatable mattress according to claim 1, wherein an internal portion and a circumferential edge of the inflatable mattress are both subjected to processing through hot pressing or radio frequency welding so as to form at least one jointed site in the internal portion of the inflatable mattress, with a part that is not subjected to processing of hot pressing or radio frequency welding being formed as a flow channel.

3. The improved structure of the inflatable mattress according to claim 2, wherein the flow channel is arranged to curve forth and back between two opposite ends of the inflatable mattress as extending from one of the ends of the inflatable mattress toward an opposite one of the ends.

4. The improved structure of the inflatable mattress according to claim 1, wherein the plurality of openings of the gas penetrating layer are formed through being punched with a punching machine.

5. The improved structure of the inflatable mattress according to claim 1, wherein the gas blocking layer and the gas penetrating layer are each formed of a thermoplastic polyurethane (TPU) film.

6. The improved structure of the inflatable mattress according to claim 5, wherein the TPU film further comprises hydrophilic groups contained therein.

7. The improved structure of the inflatable mattress according to claim 1, wherein the upper surface layer has a thickness that is greater than a thickness of the lower surface layer.

8. The improved structure of the inflatable mattress according to claim 7, wherein the upper surface layer and the lower surface layer each comprise a piece of fabric.

9. The improved structure of the inflatable mattress according to claim 1, wherein the inflatable mattress is combinable with an internal side of bedding.

10. An inflatable mattress system, comprising:
an inflatable mattress, which comprises an upper surface layer and a lower surface layer, and a gas blocking layer and a gas penetrating layer arranged in sequence, from bottom to top, between the upper surface layer and the lower surface layer, wherein the gas penetrating layer is formed with a plurality of openings; circumferential edges of the upper surface layer, the gas blocking layer, the gas penetrating layer, and the lower surface layer are processed to form hermetic sealing to form an inflatable mattress; and the inflatable mattress is provided with a gas inlet hole; and
a gas supply module, which comprises a heating machine and a gas supply tube, wherein the gas supply tube is connectable to the gas inlet hole to supply heated gas generated by the heating machine into a receiving space of the inflatable mattress.

11. The inflatable mattress system according to claim 10, wherein an internal portion and a circumferential edge of the inflatable mattress are both subjected to processing through hot pressing or radio frequency welding so as to form at least one jointed site in the internal portion of the inflatable mattress, with a part that is not subjected to processing of hot pressing or radio frequency welding being formed as a flow channel.

12. The inflatable mattress system according to claim 11, wherein the flow channel is arranged to curve forth and back between two opposite ends of the inflatable mattress as extending from one of the ends of the inflatable mattress toward an opposite one of the ends.

13. The inflatable mattress system according to claim 10, wherein the plurality of openings of the gas penetrating layer are formed through being punched with a punching machine.

14. The inflatable mattress system according to claim 10, wherein the gas blocking layer and the gas penetrating layer are each formed of a thermoplastic polyurethane (TPU) film.

15. The inflatable mattress system according to claim 14, wherein the TPU film further comprises hydrophilic groups contained therein.

16. The inflatable mattress system according to claim 10, wherein the upper surface layer has a thickness that is greater than a thickness of the lower surface layer.

17. The inflatable mattress system according to claim 16, wherein the upper surface layer and the lower surface layer each comprise a piece of fabric.

18. The inflatable mattress system according to claim 10, wherein the inflatable mattress is combinable with an internal side of bedding.

19. The inflatable mattress system according to claim 10, wherein the heating machine further comprises a temperature control unit.

20. The inflatable mattress system according to claim 10, wherein the heating machine further comprises a timer unit.
